(19) United States
(12) Patent Application Publication
(10) Pub. No.: US 2019/0244156 A1
(43) Pub. Date: Aug. 8, 2019

(54) A COMPUTERIZED METHOD AND A SYSTEM FOR DYNAMIC COMMUNICATION

(71) Applicant: Tree House Technologies Limited, Cambridge (GB)

(72) Inventor: Sikander HAUSER, Cambridge (GB)

(21) Appl. No.: 16/333,307

(22) PCT Filed: Sep. 11, 2017
(86) PCT No.: PCT/GB2017/052644

§ 371 Date: Mar. 14, 2019

(30) Foreign Application Priority Data
Sep. 14, 2016 (GB) 1615620.0

(51) Int. Cl. G06Q 10/06; G06Q 10/10

(52) U.S. Cl. CPC G06Q 10/063116; G06Q 10/1097; G06Q 10/06312

(57) ABSTRACT

A computerized network is proposed including a server and a plurality of mobile communication devices operated by respective users. One of the users can send a task message to the other users, defining one or more components of the task. Each recipient of the task message can associate themselves with one or more of the components of the task, and the task message is updated on each of the communication devices to indicate this. Similarly one of the users can send a proposal message to the other users, defining one or more options. Each recipient of the proposal message can accept or decline one or more of the options, and the proposal message is updated on each of the communication devices to indicate this. If multiple proposal or task messages are sent, then options in one proposal message can be removed due to responses to another of the proposal messages.

### FIELD OF THE INVENTION

The present invention relates to a computer-implemented method for communication in a network, and to a communication system operative to perform the method.

### BACKGROUND OF THE INVENTION

Since the 1990s, sending text messages via short messaging services (SMS) on mobile communication devices has been popular amongst individuals and groups. With the arrival of smart phones, group-texting via instant-messaging (IM) applications has increased the popularity of text message services and is now a common mechanism to prepare, organise or facilitate decision making among mobile users. However, the tools available today remain limited to a static exchange of messages. Thus, forming a plan to coordinate decisions made by a plurality of users requires a series of messages (“message ping-pong”) before all participants agree on an outcome. A given individual may have to read a large number of messages to understand the discussion which is taking place. Scrolling through many messages is a time-consuming and annoying process, especially if the screen of the individual's mobile device is small. Furthermore, if the individual is part of several conversations, he or she may have to repeatedly move between them, seeing only one at a time. At the same time, the user may have to move between multiple software applications running on the communication device, such as a calendar application and the IM application which is handling the messages. For all these reasons, there is potential for making a mistake leading to the collective decision being erroneous. Furthermore, the time taken to read the messages drains the battery of the mobile device, and downloading all the messages increases bandwidth consumption.

Although there are other software services which permit users to form a collective decision, they require further actions by the participants to setup, use and reply outside the core applications of a mobile device (e.g. that is, the email client and browser or other application), and they do not change the static ping-pong nature of such exchanges.

Further problems arise if a given individual is participating in multiple simultaneous text message discussions, for example trying to agree a first time to meet a first group of people (e.g. friends) while simultaneously trying to agree a second time to meet a second group of people (e.g. work colleagues). There is potential for the individual to make conflicting commitments. Even if this does not occur, the complex discussion process can lead to a sub-optimal result. That is, meeting times may be chosen which are less convenient, or at which fewer of the people are available, than other times which might have been selected.

Certain online systems exist which make it possible for a group of individuals to reach a decision. For example, online spreadsheets enable multiple individuals to view and edit a table using browsers on their respective mobile devices. However, the functionality of this service is very limited: each individual essentially has to notice when one of the others has amended the spreadsheet in a way which permits affects them. Although the individuals can be sent notifications that a change has been made, they would have to call up the spreadsheet to understand the significance (if any) of the change to them. Furthermore, the notifications would be received using a different software application from the one which the individuals use to view the spreadsheet (unless the software application is a browser which accesses both an online spreadsheet site and an online webmail site, in which case the software application is not tailored to the needs of either); so again the individuals would have to switch between applications (or, in the case of browser, between different tabs and/or websites). This effect is amplified if multiple spreadsheets across multiple groups are being updated.

Such systems are particularly difficult to use for an individual who is in multiple groups of individuals, each of which is simultaneously trying to allot tasks between them. Although it would be possible to set up a separate spreadsheet for each group of individuals, this becomes problematic when the decisions of members of one group impact on the decisions of the other group. For example, if a given task may be performed by members of either group, then once a certain member of either group agrees to perform it, the members of the other group should be notified of this fact. This is hard to implement with current technology.

### SUMMARY OF THE INVENTION

The present invention aims to provide new and useful communication method and communication system employing the method, particularly for people who are operating mobile communication devices.

In particular, the communication system may be one comprising a plurality of communication devices (in particular, mobile communication devices, such as mobile telephones, smartphones, or tablet computers) which all access a telecommunication network, such as a public access telecommunications network. The communication devices may be operative to send and receive communications by “instant messaging”, email and/or as SMS communications. That is, the communications may be in the form of a short text message. The communications may be compatible with (existing or future) instant messaging protocols, email protocols (such as SMTP—simple mail transfer protocol), web protocols (such as XML), or SMS communication protocols.

The communications may be sent over a telecommunication network (such as a public-access telecommunication network), to users who are located in different locations, such as in different towns or even countries. Alternatively or additionally, the communications may be sent over a local network, for example by near-field communication (NFC) or bluetooth, such as between users who may be in the same room.

The communications are managed by a software application on each communication device which provides a graphical user interface (GUI). The application may be operative also for viewing conventional IM and/or SMS communications sent to the corresponding communication device.

The present invention is based on the concept of multiple users of a communication system collectively making a decision using a message containing selectable options. A message defining selectable options is here referred to as an “action message”, and we consider two types of action message: task messages (which define the components of a task which have to be allocated to corresponding individuals) and proposal messages (which contain options which are not task components).

The decision may, for example, be who will perform various components of a task (in which case the action message is a task message), or when and/or where the users will meet, or any other logistical decision (a proposal message). The selectable options of a proposal message may for example be a plurality of alternative possibilities for a result of the decision (e.g. a list of times at which it is proposed to meet), and/or a question which needs a yes/no answer (e.g. “can we meet one hour earlier than previously agreed?”).

The action message is viewable by an initiator of the action message and by recipients of the action message. As recipients of the action message respond to it, the action message is dynamically (that is, essentially instantaneously updated, such as with a delay of under 5 seconds or more preferably under 2 seconds), to include data indicative of their responses. Thus, it is not necessary for the participants in the decision process to review individually a large number of responses to the action message. Instead, the multiple responses into a single updated version of the original action message, so that one of the users has only to view that one action message to understand the discussion. This saves time (and thus preserves battery life) and bandwidth, and reduces the risk of error. The management of the action messages and the responses is performed by a single software application running on any given communication device, so that the user does not have to switch between multiple applications.

The format of the action messages is preferably designed to collate all the responses in an easily comprehensible manner. Thus, the invention is applicable to mobile communication devices having a small screen (e.g. with a diagonal length no more than 10 cms). The invention is thus readily applicable to the limited capabilities of a mobile communication device, which contrast with the more sophisticated capabilities of a personal computer.

A first aspect of the invention proposes, in general terms, that a plurality of users (“individuals”) are provided with a software application to view a task message which is in a format comprising a portion designating at least one task component. The application permits any of the users to respond to the task message by accepting one or more of the task components (i.e. agreeing to perform of that task component, or at least ensure it is performed by others). Upon one or more users doing so, the mobile communication device(s) of those user(s) transmit a response message indicating the acceptance. A database record relating to the task message is updated to indicate the acceptance. Thus, the user(s) become associated with the task component.

The user(s) may have other options for responses. For example, they may have the option to refuse a task component, and/or an option which says that he or she is considering performing the task, and/or an option to propose another of the user(s) to be the person who performs the task component. In any of these cases, the individual's mobile communication device transmits a response message which indicates the option which the user has taken.

An update message is then sent to the mobile phones of all the recipients of the task message. In response to the update message, the task message is then displayed in the mobile devices of all the other users in an updated form (i.e. as an “modified task message”) showing that the task component has been associated with one or more user(s) who accepted it (or chose another response option). Those one or more users gain “ownership” of the task and/or confirm whichever other response the recipient requested Thus, the invention may allow the plurality of users to partition the components of the task among them without having to view multiple messages.

The original (i.e. unmodified) task message is preferably displayed on a graphical user interface generated by a software application running on each mobile communication device. The modified task message is typically displayed instead of, and in place of, the original task message on the graphical user interface. Thus, the number of messages which a given individual receives is not increased by the updating operation.

The task message may be initiated by one of the users (the “initiator”), who defines at least one task component. Optionally, he or she may do this by completing the fields of a pre-defined message template.

Optionally, the system may allow only one user to become associated with each task. Alternatively, the user who defines any task component may be able to assign a given participant number to it, indicating the maximum number of users who can become associated with it. By default, the participant number may be “one”. However, one of the task components may be a task (such as putting up a large tent, or manning a bobsleigh) which requires multiple participants. In such a case, the participant number may be set to be greater than one. Optionally other users may be able to modify the participant number.

Once a number of users have become associated with the task which component is equal to the participant number, additional users are not able to be associated with the task component.

Optionally, a task component may be associated with one or more individual attributes, and only individuals who satisfy one or more criteria relating to the individual attributes can become associated with the task component. For example, one individual attribute may be a list of one or more specific individuals who can be become associated with the task component, and the corresponding criterion may be that the individual who accepts the task component is one of those individuals. In another example, a criterion may be that an individual's age, email domain or tags match corresponding individual attributes associated with the task component. In another example, a criterion may be whether a property of an individual as observed by the system (e,g. a history of completing task components, association with other groups, geo-location, first time log-on, first time joining a group, owner of at least one task in a certain group or within a certain task message, anyone within a group who is overdue on their task, etc) matches a corresponding individual attribute associated with the task component.

In one form, the communication may be coordinated by a server (such as a virtual server provided on a cloud computing service) which maintains a database (a “message database”) with a record for each task message (a “task record”). The record may be created when the initiator initiates the task message. The record includes an indication of the task components, and any of the users who have become associated with them.

In one possibility, the initiator may create the task message by a process which includes at least one step of the software application on his or her mobile communication device communicating with the server. The record may be created in this process. In this case the task message may be sent by the server to the communication devices of the other users (via a telecommunication network).

In another possibility, the initiator may create the task message independent of the server. If so, the mobile communication device initiator may send the task message to the other users directly (i.e. via a telecommunications network, but not using the server), and send the server a notification of the task message (e.g. a copy of the task message). The server may then create the record from the notification. In one case, the initiator may create the task message when the initiator's communication device is “offline” (e.g. not able communicate with the server) and only send it when it becomes online again.

The updating of the task message on each mobile communication device may be performed by the software application on each mobile communication device communicating with the server to obtain information from the record. The communication may be initiated by the software application polling the server, e.g. at intervals, or by the server initiating communication with the mobile communication devices (e.g. periodically, or in response to receiving one or more update messages).

In an alternative realisation of the communication network, the server could be omitted, and the software applications on the mobile communication devices could communicate directly with each other (via a telecommunications network). For example, the mobile communication device of the initiator could send the task message directly via a telecommunications network to the mobile communication devices of the other users, and the mobile communication devices of the other users could send update messages directly to each of the recipients of the task message. A record for the task message could be stored on the initiator's mobile communication device, and updated as responses are received. In other words, the initiator's mobile communication device may play the role of the server described above.

Preferably, the system provides the functionality for some or all of the users to modify the task components of the task message, such as by adding one or more task components to the task message. The modified task message is then shown on each of the mobile devices. For example, if the task related to preparations for an event (such as a sporting event, a social meeting or a business meeting), an initiator of the task might envisage certain preparatory task components (e.g. organising who will compete at a sporting event, or who will prepare certain food dishes for the event), but other users may add additional tasks which the initiator did not include in the original task message and/or divide a first task component into multiple task components representing respective elements of the first task component.

In another possibility, a given user may be able to define a number of components of a certain task component, while the original task component continues to exist. For example, suppose that a given task component is a management task. A given user may accept responsibility for the task component being completed, but not necessarily wish to perform the entire task component, and so, while retaining ownership of the management task itself, may define two components of the task component, which other users (e.g. ones who are more junior staff members) are able to accept. Thus, there may be a hierarchy of task components in which at least one user is responsible for a certain task component (an “upper” level task component) being completed, while other user(s) are responsible completion of “lower level” task components, which are components of the upper level task component.

For example, if the first task component were to bring food to an event, a given user might modify the first task component to separate it into multiple task components representing different kinds of food. Each of the users would then see, instead of the original task message, a modified task message in which the first task component is replaced by the multiple task components.

A user who modifies the task components of a task message may have the option of accepting one or more of the modified task components, but may not be under an obligation to do so.

A second aspect of the invention, the invention proposes a communication method in which a user (referred to as the “initiator”) is able to transmit a first action message to communication devices of a first group of the users, and a second action message to communication devices of a second group of the users. Each of the groups of users contains one or more (normally more than one) users, and the first and second groups may be the same or different.

Upon users selecting one or more of the options in the first action message, the second action message is modified to modify the options of the second message, and the recipients of second message are shown the second message in the modified form. (Note that the explanation above is not intended to imply that the first message is created or transmitted before the second message.)

Thus, the second aspect of the invention makes it possible for a first decision made by the first group of users, to be coordinated with a second decision made by the second group of users. In particular, one of the messages may be modified by the invention to remove options which are not compatible with options selected by one or more of the users who received the other of the messages.

The first and second action messages may be “proposal messages”. That is, they may each contain one or more selectable options which are not task components.

For example, if the initiator wants to reach a collective decision with the first group of users to meet a certain time, and with the second group of users to meet at a second time, the first message may contain a first list of time options, and the second message may contain a second list of time options. Some of the time options on the first list may be the same as, or proximate to (i.e. differ by less than a certain threshold amount of time from), time options on the second list. If one of the time options on the first list is selected by one of the first group of users (or, in an alternative, by a number of the first group of users which is above a threshold), the other message is updated to eliminate the same or proximate time options on the second list.

The threshold mentioned in the preceding sentence may be chosen to be high enough that, if that number of the first group of users have chosen that option, then this is a good prediction of which option the first group of users will eventually decide on. The system may take other factors into account also. For example, in the case that the action messages are proposal messages, the system (e.g. any one of the communication devices 1a, 1b, . . . , 1N) may have access to database (a calendar) for the corresponding user in the first group of users, and be operative to compare the options in the first proposal message to the data in the database, to form a prediction of how likely the individual is to accept that option, even though that individual has not yet responded to the first proposal message. If the system predicts that the first group of users is likely to choose a certain one of the options for the first proposal message, it may remove conflicting options from the second proposal message.

Optionally, the GUI for each group of users may display the corresponding one of the message in a format indicating how many of that group of users have selected one or more of the corresponding options.

Again, the second aspect of the invention may be implemented using a server (e.g. a virtual server provided on a cloud computing platform) including a message database for storing a respective record (an “action record”) for each of the proposal messages, including the options associated with them and which users have selected those options. If the action message is a proposal message, the action message is of a first type, referred to as a “proposal record”; if the action message is a task message, the action record is of a second type, referred to as a “task record. The first and second action messages as displayed on the users' communication devices are updated (e.g. periodically) to confirm to the record. For example, when any of the first or second group of users selects an option, a response message is sent to the server which updates the corresponding action record. At this stage the server may update the options associated with the other message, and modify the record accordingly. The server sends an update message to the communication devices of the initiator and the recipients of the action messages, to instruct the corresponding software application to update the proposal messages.

Alternatively, in other embodiments, the server could be omitted. In this case, the records could be stored in one of the communication devices (e.g. the communication device of the initiator).

Note that in both aspects of the invention the update message(s) may only be sent upon one of the individuals taking an action (i.e. the individual may “pull” the update message). For example, the action may be one of the users opening a GUI page of the software application which displays the task message. When this happens, the user's mobile communication device may pull the update message(s) from a remote location, such as the server 7.

Following the response message, and prior to the update message, an update notification may be “pushed” to one of more of the mobile devices, indicating that a response has been received. The software applications may display indications of the existence of these response notifications (e.g. on a certain GUI which summarizes all the response notifications for multiple task and/or proposal messages). This indicates to the individual that he should take the action which causes the update message to be sent. Optionally an update notification may be also be pushed to one or more of the mobile devices to indicate that another new communication has been received (e.g. a message specifying a new task; or a new message not related to the tasks, such as a conventional IM message; or an alert relating to task components the individual has previously accepted).

Optionally, the response messages may be filtered according to one or more significance criteria, and the response notification is only sent to a given individual if the response is relevant to the individual according to the criteria. For example, if the response message is just to say that a certain individual declines to perform a certain task component, this response may not be of sufficient relevance to another of the individuals for an update notification may be sent to that individual's communication device. If the response message from a first individual is to propose a second individual for a certain task component, then the significance criterion might indicate that the second individual should receive an update notification, but that other users may not.

Note that often a decision has to be reached in which both aspects of the invention are useful. For example, suppose that a certain task is to be performed by two groups of people. An initiator may set up a first task message which is sent to one of the groups, and a second task message which is sent to the other of the groups. Each of these task messages may be considered as a proposal message. If the task includes one or more of the task components which can be performed by either group, then this task component could be included in both task messages. When one of the recipients of one of the task messages (say, the first task message) accepts that task component, then that individual's mobile communication device transmits a response message, and that individual becomes associated with the task. Then the second message is modified to remove that task component, or show it as allocated.

The invention can be expressed as the methods of carrying out the invention. Alternatively, it can be expressed in terms of the programmed server including a data storage device (such as a tangible data storage device for storing program instructions in non-transitory form) carrying program method instructions operative to cause the server to carry out the method. Alternatively, it can be expressed in terms of the software application running on any of the mobile communication devices (i.e., as a computer program product comprising program instructions which control the operation of a processor of the mobile communication device).

The term “communication device” is used here to mean a communication device which includes a processor, a data storage device and a communication interface, typically a wireless communication interface. The term “mobile communication device” means a communication device which is conventionally transported by an individual from one place to another, e.g. carried. Thus, the term mobile communication device includes a smartphone or tablet computer, but in another example the mobile communication devices may be part of a vehicle.

Although the invention is particularly suitable for implementation with a network of mobile communication devices, it may also be implanted using communication devices which are not mobile. For example, the internet-of-things paradigm envisages that objects such as household objects are enabled to communicate, any of the communication devices may be such a household object. For example, if the object were a refrigerator, then an individual may be able use the refrigerator to act as a communication device, to create a task message which is to buy food or drink items.

### BRIEF DESCRIPTION OF THE EMBODIMENTS

An exemplary embodiment of the invention will now be described with reference to the following figures, in which:

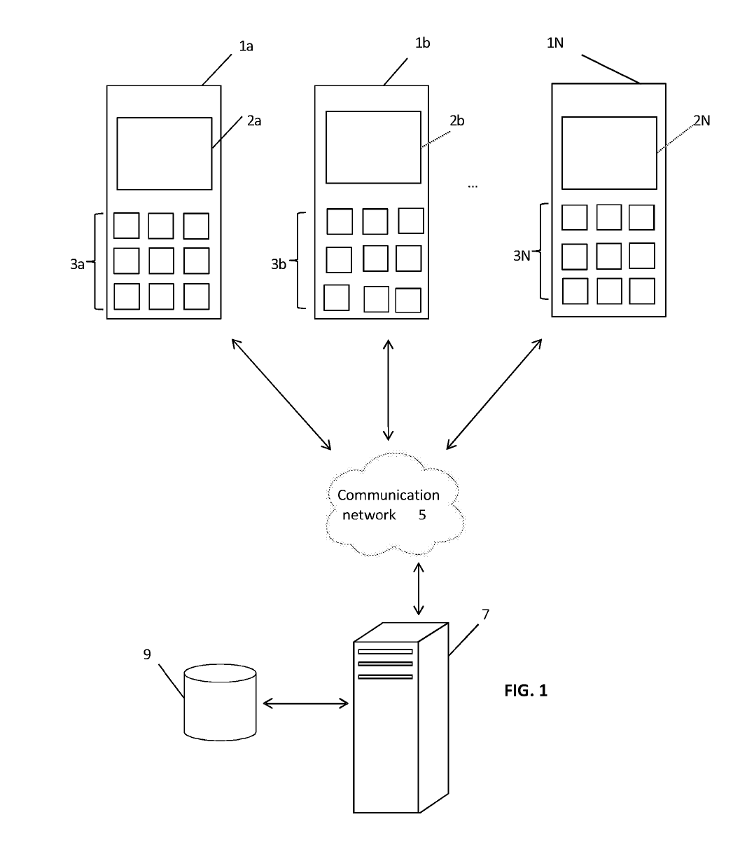

FIG. 1 shows a computerized network which is an embodiment of the invention;

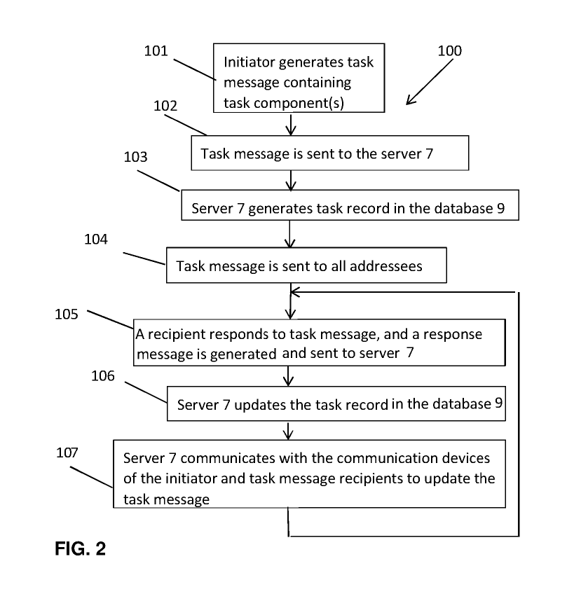

FIG. 2 shows the steps of a first communication method which is an embodiment of the invention, and which can be performed using the computerized network of FIG. 1;

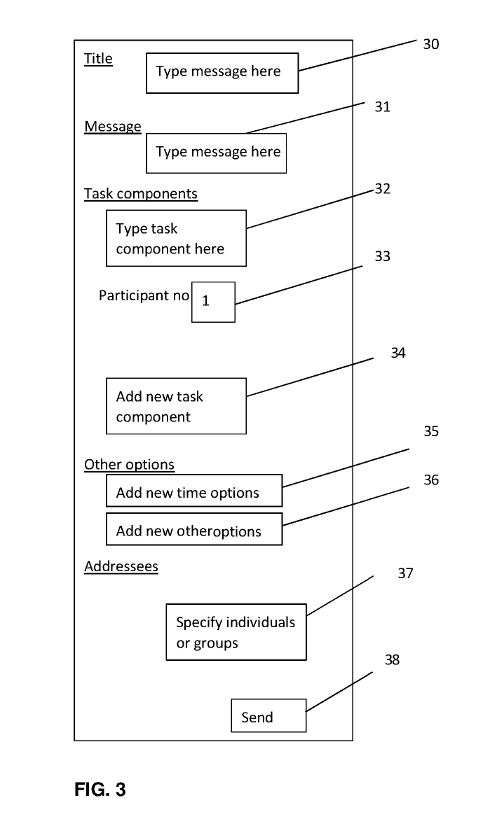

FIG. 3 shows a template for creating an action message;

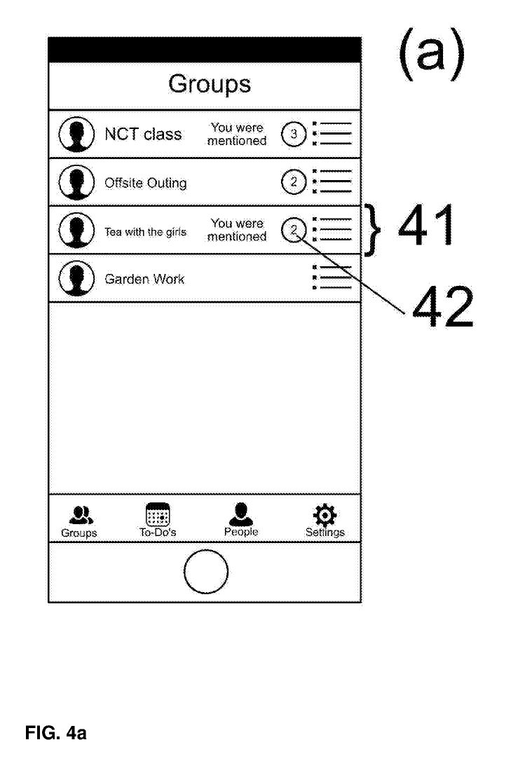

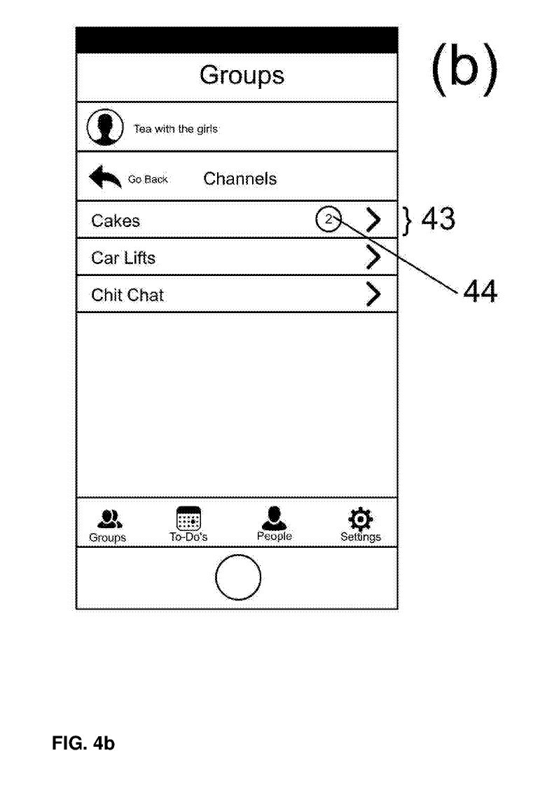

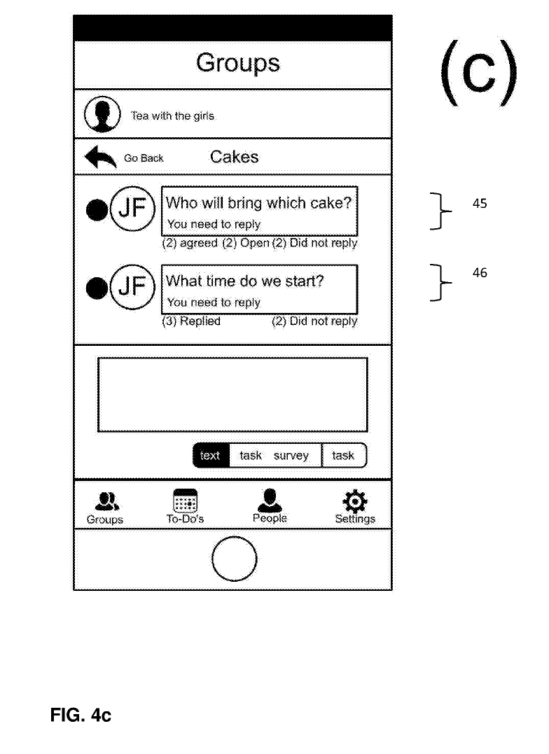

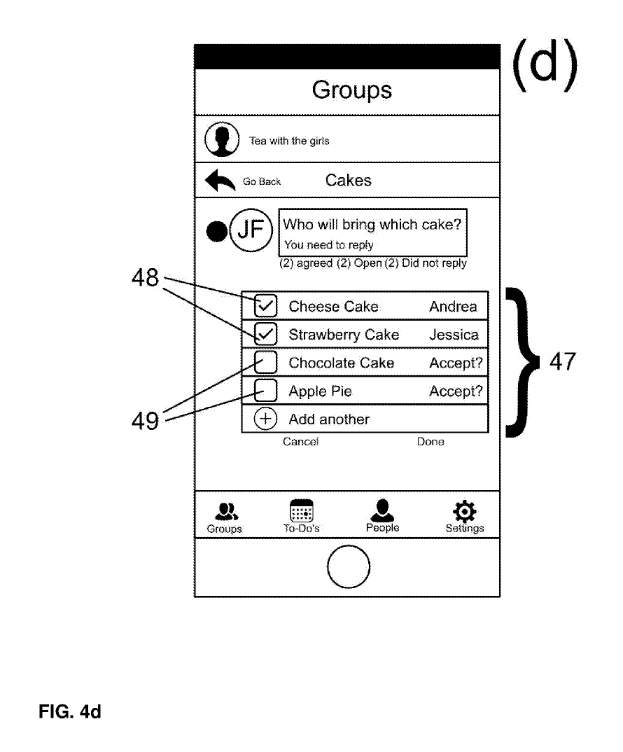

FIG. 4, which is composed of FIGS. 4(a) to 4(d), shows screens which are displayed at certain times during the method of FIG. 2 by the screens of the mobile communication devices of the network of FIG. 1;

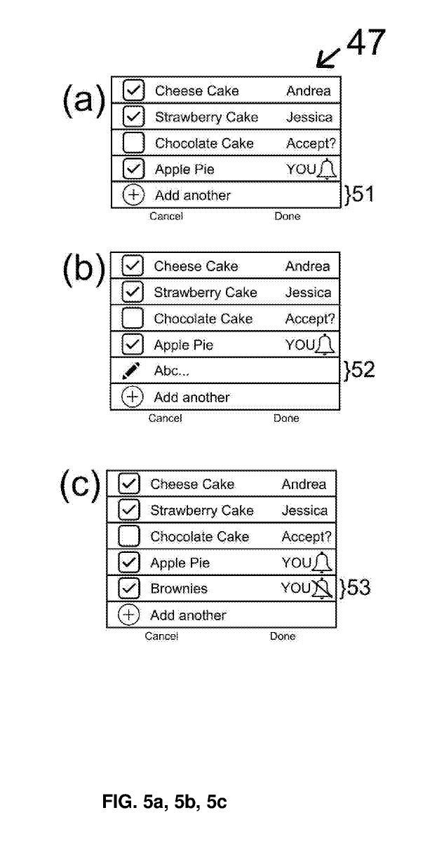

FIG. 5, which is composed of FIGS. 5(a) to 5(c), shows portions of screens which are displayed at certain times during the method of FIG. 2 by the screens of the mobile communication devices of the network of FIG. 1;

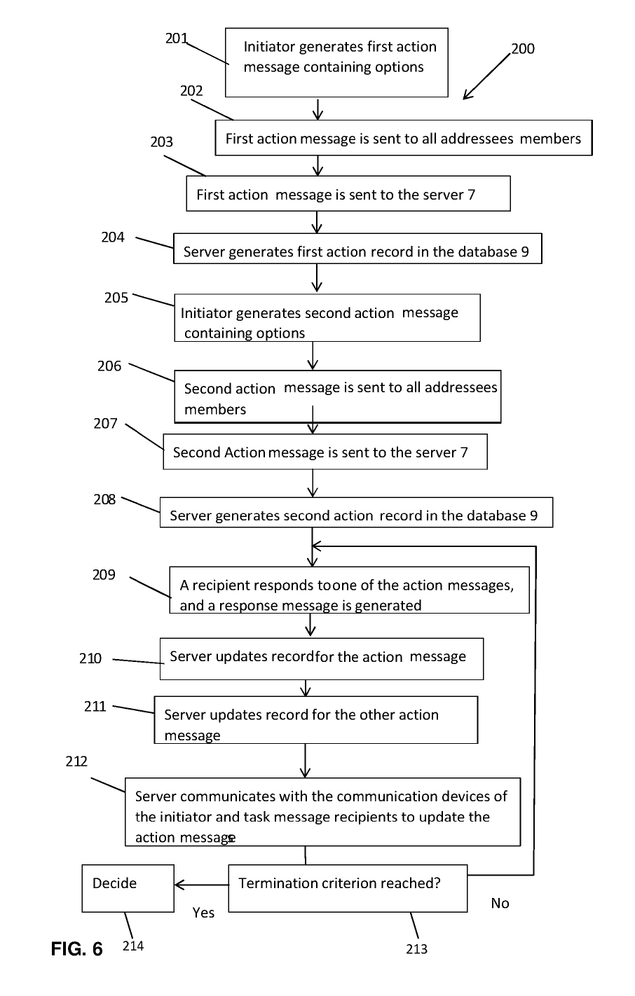

FIG. 6 shows the steps of a second communication method which is an embodiment of the invention, and which can be performed using the computerized network of FIG. 1;

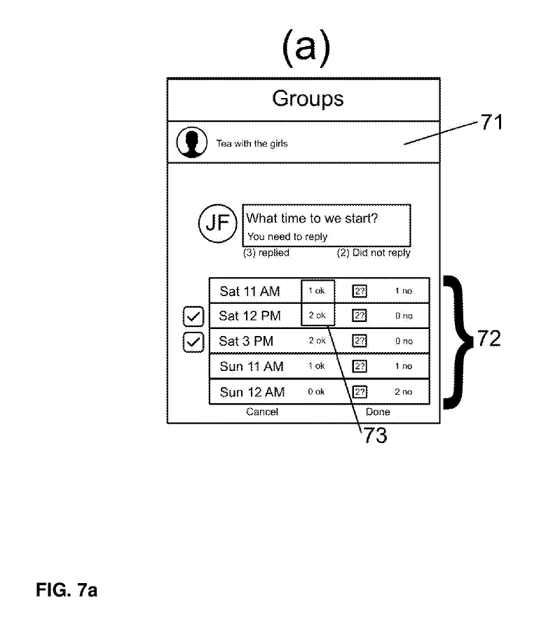

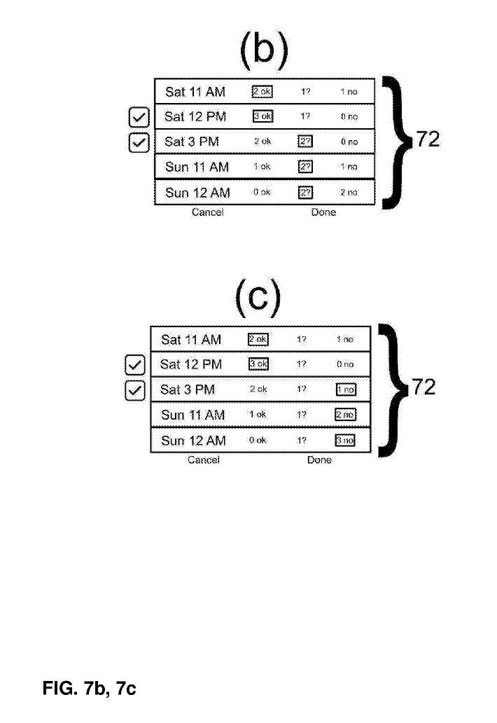

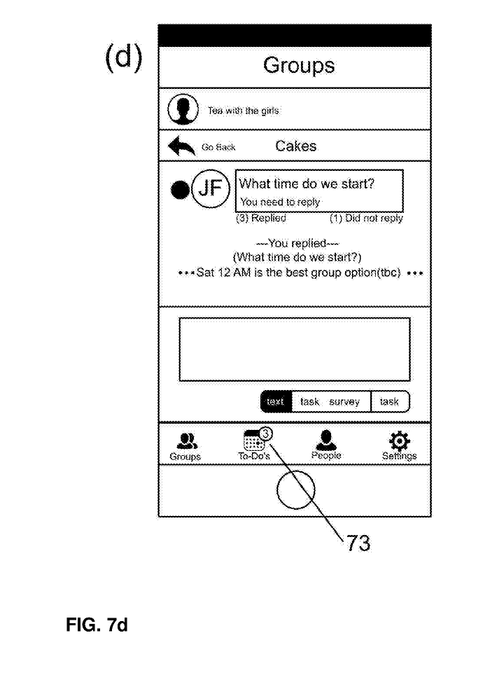

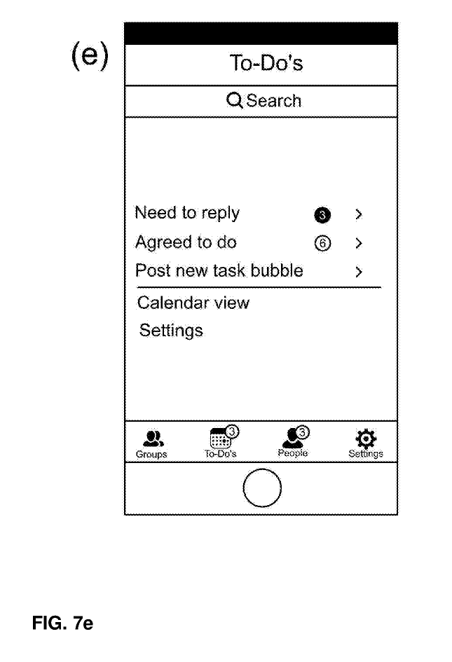

FIG. 7, which is composed of FIGS. 7(a) to 7(e), shows screens which are displayed at certain times during the method of FIG. 6 by the screens of the mobile communication devices of the network of FIG. 1;

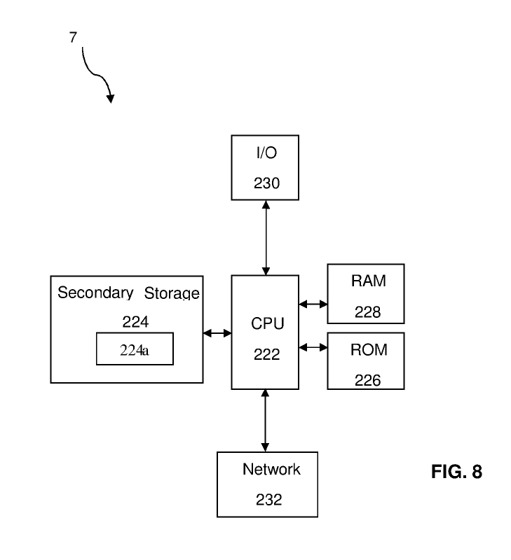

FIG. 8 shows schematically the structure of a server of the network of FIG. 1; and

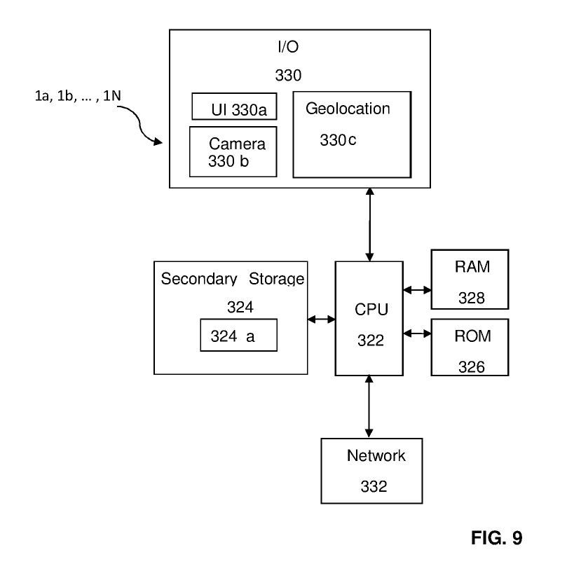

FIG. 9 shows schematically the structure of a communication device of the network of FIG. 1.

### DETAILED DESCRIPTION OF THE EMBODIMENTS

Referring to FIG. 1, a computerized network is shown which is an embodiment of the invention. The network includes a number N (which may be at least 10, at least 1,000 or at least 1,000,000) mobile communication devices 1a, 1b, . . . , 1N, which may be mobile telephones. Each mobile communication device 1a, 1b, . . . , 1N includes a respective screen 2a, 2b, 2N and a respective set of data input devices (e.g. buttons) 3a, 3b, 3N. The communication devices 1a, 1b, . . . , 1N are each able to communicate with a telecommunication network 5 which may be the public telephone system. The possible structure of the communication devices 1a, 1b, . . . , 1N is described below with reference to FIG. 9. Each of the communication devices 1a, 1b, . . . , 1N is associated with (e.g. operated by, and usually owned by) a respective individual, referred to here as a “user”.

A software application is installed on each of the communication devices 1a, 1b, . . . , 1N for handing communications within the network. If the communication devices 1a, 1b, . . . , 1N have different operating systems, then the software application may be a corresponding native application. For this purpose the server 7 may be enabled to communicate in a standard protocol, such as HTMLS, with all the software applications; alternatively, the server 7 may be enabled to recognize the operating system of a given one of the communication devices 1a, 1b, . . . , 1N and communicate with it using a corresponding protocol.

Preferably, this software application is operative to manage standard IM and/or SMS communications, and display them to the corresponding user using a GUI running on the corresponding communication device. That is, the software application is controllable by the user to present to him or her messages which have been sent to the user. The mobile phone and/or user is typically associated with an identity code which is used to address these communications, e.g. in the case of SMS communications, the identity code is a telephone number of the communication devices 1a, 1b, . . . , 1N.

The network further includes a server 7. Although a physical server is shown, the server 7 may alternatively be implemented as a virtual server on a cloud computing platform. The server 7 has access to a message database 9, which stores respective records associated with messages. Each of the software applications is able to communicate with the server 7 via the communication network 5.

We now turn to FIG. 2 and describe a first method 100 which can be performed by the network of FIG. 1.

In step 101, one of the users (referred to here as an “initiator”) operates the software application to open a message template illustrated in FIG. 3. This is displayed on the GUI. The initiator wants to organize an event. In an example, this may be a tea party.

The initiator enters a title “Cakes” into a text field 30 indicating the topic of the conversation.

The organization of the tea party requires that the participants perform the task of bringing cakes to eat. The message template includes an area 31 where the initiator can input a text, such as “Who will bring which cake”.

Suppose that the initiator thinks that there should be cheesecake, strawberry cake, chocolate muffins and apple pie. The initiator types “cheesecake” into the box 32, to indicate that one task component is bringing cheesecake.

A box 33 is provided in which the number of people who should perform this task component (the “participant number”). By default this box may be populated with “1”, and the initiator decides not to change this.

Instead, the initiator clicks on box 34 indicating that another task component will be defined. The GUI then displays two boxes (not shown) equivalent to boxes 32 and 33 for the initiator to add the task component “apple pie”.

The initiator goes through this process twice more to add the task components “chocolate muffins” and “apple pie”.

The initiator then clicks on box 37, which initiates a procedure in which the initiator chooses who the message is sent to (the addressees). In this case the addressees are a pre-defined user group called “Tea with the girls”. The initiator is able to select the user group from an address book accessible to the software application. In an alternative, the addresses may be selected individually by entering individual addresses in to the box 37.

Optionally, the initiator may have the option to specify, for each task component (or for the task as a whole) one or more individual attributes, such that only individuals who have these attributes can become associated with the task components. This is explained in more detail below.

Optionally, the initiator may have the option to specify additional data relating to performance of any task component. The additional data may for example include any one or more of: a time by which the task component must be completed; a time at which a reminder will be given to any individual with whom the task component become associated; visibility to others; or one or more data files which are transmitted to an individual who become associated with the task component to assist them (e.g. instructions).

The initiator then clicks on the send button 38.

In step 102 the communication device of the initiator sends the task message to the server 7.

In step 103, the server sets up a record for the task (a “task record”) in the database 9. The task record contains all the data in the task message.

In step 104, the communication device sends the task message to all the respective mobile communication devices of all the addressees (in this case, the users in the group “tea with the girls”) containing all the information the user entered in step 101. The software application on each device may perform a process to attract the attention of the corresponding user (e.g. generate a sound or vibrate). The communication device of the initiator retains a copy of the task message, which can be viewed using the software application.

Note that step 104 may be performed before step 102 or before step 103 or simultaneously with either of them. Alternatively, in a variant, step 104 may be replaced with a step, following step 102 or 103, in which the server 7 transmits the task message to the addressees.

Consider one of the users to whom the task message is sent in step 104 (“the recipient”). In step 105 the recipient opens the software application, and thereby views all the messages received.

FIG. 4(a) shows how the recipient's screen appears at this stage. It is a to-do list which has three rows, each indicating a group of which the user is a member. The row 41, which corresponds to the group “tea with the girls” contains an icon “2” 42 indicating that there two messages on it to which the recipient has to respond. One of these is the task message generated in the step 101.

As described below, the present system implements multiple types of to-do list, and each is not just useful to display data. It can also be used as a basis to receive data input to manage proposals (add a new action, change an existing action, manage alert settings, etc.). Thus, any of the to-do lists enables to user to act on the displayed data without jumping across different groups and screens again (e.g. accessing a proposal which was sent to a certain group by opening a list of messages sent to that group).

Taking the example of the to-do list of FIG. 4(a), the recipient clicks on the row 41, and the GUI displays the screen shown in FIG. 4(b). For this group there are three different topics, with the respective titles “Cakes”, “Car lifts” and “Chit Chat”. A row 43 represents the topic “cakes”. Row 43 contains an icon “2” 44 indicating that there two messages on it to which the recipient has to respond. One of these is the task message generated in the step 101.

The recipient clicks on the row 43, and the GUI displays the screen shown in FIG. 4(c), listing messages for the topic “cakes”. Under the heading “cakes” there are two messages to respond to. One of these, represented by the area 44, is the task message generated in step 101. The other message, represented by the area 45, is a “proposal message”, as described below with reference to FIGS. 6 and 7. The areas 45 may be termed a “task bubble”, in that they are like a conventional SMS bubble except that they are associated with the selectable task components.

The recipient clicks on row 45, and the GUI displays the screen shown in FIG. 4(d). This shows in area 47 the four task components. The two task components “cheesecake” and “strawberry cake” have already been associated respectively with users with names Andrea and Jessica (who are also part of the user group “tea with the girls”). This is indicated by the tick icons 48 and the names Andrea and Jessica displayed to the right of area 47. The task components “chocolate muffins” and “apply pie” are as yet not associated with any user, as indicated by the circles 49 and the word “accept?” at the right of area 47.

The recipient clicks on the word “accept” which in the same row as the word “apple pie”. By doing this the recipient has accepted the task.

The mobile communication device associated with the recipient transmits a response message to the server 7, indicating what the recipient has done. This completes step 105.

In step 206 the server reacts to the response message, which may include updating the record for the task.

Note, however, that it may happen that by the time the response message is received at the server 7, the server 7 has already received a message from another user accepting the “apple pie” task component, and that the task record has be updated to show the other user as associated with the task component. Since a number of users equal to the participant number (i.e. one) has already been associated with the task component, in step 105 the server 7 does not change the record again. It may however send a message to the recipient saying that the task component is already assigned.

Furthermore, the server 7 may determine whether the individual in respect of whom the response message was generated, satisfies one or more criteria relating to individual attributes associated with the task component. For example, the individual attributes may include a specific list of individuals, specified by the initiator, who are allowed to associate themselves with the task. In another example, the individual attributes may include properties of the individuals which can be determined based on data the individuals have given about themselves (e.g. the individuals' age, email domain, tags). In another example, the individual attributes may be ones observed by the system (history of tasks, association with other groups, geo-location, first time log-on, first time joining a group, owner of at least one task in a certain group or within a certain task message, anyone within a group who is overdue on their task, etc.). If the server 7 determines that the individual who accepted the “apple pie” component does not meet the one or more individual criteria, the server 7 may generate a message to the individual to explain why, but the server 7 does not change the task record.

Otherwise, in step 106 the server 7 updates the record for the task, to show the recipient to be associated with the task component “apple pie”.

In step 107 the server 7 communicates with the communication devices 1a, 1b, . . . , 1N of the initiator and the task message recipients, and during this communication sends them an update message which instructs them that that the task message should be updated. The update message contains at least data specifying how the task message should be updated (i.e. to show the recipient as associated with the task component “apple pie”).

This communication between the server 7 and the communication devices 1a, 1b, . . . , 1N may be initiated by the server 7, for example by sending the update message. This update message may be triggered to be sent by the completion of step 106. Alternatively, the communication devices 1a, 1b, . . . , 1N may poll the server 7 (e.g. at periodically) to establish communication, and the server 7 may send the update message when the communication has been established.

The software applications running on the communication devices 1a, 1b, . . . , 1N of the initiator and all the recipients of the task message respond to the update message by updating the task message, so that it is consistent with the update message (i.e. consistent with the updated record). For example, the portion 47 of the recipient's GUI may now appear as shown in FIG. 5(a). This indicates that the task “apple pie” is now associated with the recipient, “you”. The other recipients of the task message, and the initiator, would see an identical task bubble except that the word “you” would be replaced by the name of the recipient who accepted the task component.

Optionally, step 107 may be performed in multiple stages. In one option, the server 7 may, upon modifying the record in step 106, generate an update notification which is sent to the other communication devices saying that the record has been updated. The existence of this update notification may be displayed on the other communication devices (e.g. the numbers shown by the icons 42, 44 in FIG. 4 may be calculated solely from the initial task messages and proposal messages and the response notifications). Subsequently, the recipient of the update notification may take some action (e.g. switching to a window of the GUI in which the task message is displayed) which causes the full update message to be downloaded and used to update the task message. Optionally, the update notification may only be sent if the response fulfils at least one significance criterion. For example, if the response was just to decline a task component, this response may not be sufficiently important to trigger an update notification according the significance criterion.

If, in step 101, the initiator specified additional data relating to performance of any task component, the additional data may be communicated to the communication device of the individual(s) who became associated with the task component. For example, the individual(s) communication device(s) may be instructed to generate a reminder at a time indicated by the initiator, if the task has not been completed by then. In another example, one or more data files specified by the initiator may be transmitted to the individual(s) who become associated with the task component to assist them (e.g. instructions).

The method 100 then returns to step 105, i.e. the next time one of the users of the user group responds to the task message. The loop of steps 105 to 107 can be repeated indefinitely, as the various users who received the task message respond to it. Even after all the users have responded, it may be worth the process continuing in case one of the users wants to make a further response (e.g. if one of the users finds that he or she is unable to perform a task which he or she had previously accepted, the user may send a second response message which reverses the effect of the first).

Preferably, the changes which the users are permitted to make to the task message are not limited to accepting task components (or reversing previous acceptance of task components). For example, a further type of response a user may be permitted to make in step 105 is to split an existing task component into multiple task components. For example, a task component of bringing five cakes may be split into a first task component of bringing two cakes, and a second task component of bringing five cakes.

Another type of response a user may be permitted to make in step 105 is to add a new task component. For example, the recipient who accepted the task component “apple pie” may be able to click on an area 51 of the area 47 to add a new task component to the task message. If the recipient does this the area 47 now appears as shown in FIG. 5(b), with add additional area 52 into which the recipient can add the name of the new task component. In this example, the recipient adds the name “brownies”. The communication device sends a response message to the server 7 giving details of the added task component. In step 106 the server 7 updates the record to include the new task component. In step 107, the server 7 sends an update message to the communication device of the initiator and the task message recipients to update the task message. Now, the GUIs of all the communication devices 1a, 1b, . . . , 1N of the initiator and all the task message recipients show task bubble including the new task component “brownies”, as shown in FIG. 5(c).

Note that in this process the recipient who added the task component “brownies” may become associated automatically with the added task component. In a variation of the embodiment, this may not be the case: the added task component may be initially unassigned, and only become assigned to one of the users (the initiator or one of the recipients of the original task message) when one of them specifically accepts it, and the set of steps 105-107 is performed. Furthermore, each task components has a number of settings available, for example alert settings to notify the task owner according to certain parameter (e.g. a reminder 1 week before a task is due).

Alternatively, the additional task component(s) may be generated as sub-tasks to an existing task component. Suppose that a certain task component A exists. A certain individual may be able to define a set of n sub-task components A1, A2, . . . , An. The task component A may still exist (and therefore be displayed by the communication devices of the individuals who received it), and the individual may be associated with it, but other individual(s) may be able to associate themselves selectively with one(s) of the sub-task components A1, A2, . . . An. For example, suppose that a certain task component is to provide 5 cakes. A certain individual may take charge of this task component, but rather than providing the cakes him- or herself, may define five sub-tasks for the respective cakes. Five other individuals may perform the respective sub-tasks, but the first individual remains responsible for checking that they are doing this.

In summary, the first embodiment makes it straightforward to create new task components for any user, channel or group, or mix thereof.

Once an individual has become associated with a certain task component, the individual may be able to supply data input to the corresponding communication device, to indicate the status of the task component. For example, that the task component has been completed. Upon the individual doing this, the communication device transmits a status update message to the server 7, which transmits an update message to all the other recipients of the task message to show the updated status.

### Interaction of Action Messages

We now introduce second type of action message which one of the users may initiate. This is a proposal message, which includes a number of options, e.g. times.

FIG. 6 shows the steps of a method 200 in which two action message are processed. The following explanation assumes that the action messages are proposal messages, but, as explained later, the steps of method 200 are applicable also to the handling of two task messages.

In step 201 an initiator generates a first proposal message. The initiator does this using the message template shown in FIG. 3. As for a task message, the initiator completes the field 30 (if the proposal message relates to the same event as the task message describes above, the initiator will choose the same title, e.g. “Cakes”). The initiator completes the field 31 to specify what the options relate to (e.g. “what time shall we meet).

Instead of using the areas 32, 33, 34, in the case of a proposal message the initiator may click on area 35 to add time options (that is, options for when an event may occur). If the user does this, the GUI presents a window with a number of possible times (i.e. days and times of day), and the initiator clicks on a plurality of times to set them as options. In the present example, the initiator clicks on times Saturday 11 am, Saturday 12 pm, Saturday 3 pm, Sunday 11 am, and Sunday 12 pm.

Note that if the initiator did not want the options to relate to times, he can alternatively click on area 36. In this case, the GUI presents a window in which the user can define a plurality of options using free text (e.g. the names of locations where an event may occur).

As for a task message, the initiator of a proposal message specifies the addressees of the proposal message using the area 37 of the message template. The initiator then clicks on send box 38.

In step 202, the communication device of the initiator sends the proposal message to all the respective mobile communication devices of all the addressees (in this case, the users in the group “tea with the girls”) containing all the information the user entered in step 201. The software application on each device may perform a process to attract the attention of the corresponding user (e.g. generate a sound or vibrate). The communication device of the initiator retains a copy of the proposal message, which can be viewed using the software application.

In step 203 the communication device of the initiator sends the proposal message to the server 7. Note that step 203 may be performed before step 202 or simultaneously with it. Alternatively, in a variant, step 202 may be replaced with a step in which, following step 203, the server 7 transmits the proposal message to the addressees.

In step 204, the server sets up a record for the proposal (a “proposal record”) containing all the data in the task message.

Optionally, the method includes step 205 in which the initiator generates a second proposal message. This is performed in the same way as step 201, except that the initiator chooses different text for at least box 30 and/or 31. The addressees specified in box 37 may be the same as in step 201 (e.g. if the initiator wants to ask the same users about the same event), or they may be different.

Suppose that the first and second proposal messages are both proposing times for an event which the initiator wants to attend. These times may be as follows:

| First proposal message | Second proposal message |
|---|---|
| Saturday 11am | Saturday 11.30am |
| Saturday 12pm | Saturday 12pm |
| Saturday 3pm | Saturday 6pm |
| Sun 11am | Sunday 9am |
| Sun 12pm | Sunday 12pm |

Note that one the time options from the first proposal message (12 pm on Saturday) is also a time option for the second proposal message. Also, some of the time options for the first proposal message are within a predetermined threshold (e.g. 1 hour) of times for the second proposal message (the time option of Saturday 11.30 am for the second proposal message is within 45 minutes of two time options for the first proposal message). Thus, there is a possibility of a time option being chosen for the first proposal message which is in conflict with a chosen time option for the second proposal message, meaning that the initiator will not be able to attend both events.

As discussed below, step 211 is performed to remove the possibility of such conflicts arising. To facilitate this, the initiator may notify the server 7 that the messages are associated, such that the server 7 performs step 211 in relation to this pair of messages. Alternatively, the server 7 may be operative to determine automatically that the first and second proposal emails comprise conflicting respective options.

If step 205 has been performed, then in step 206 the second proposal message is sent to all addressees in the same manner as step 202, in step 207 the second proposal message is sent to the server as in step 203, and in step 208 the server creates a second proposal record in the database.

In step 209, one of the recipients of the first proposal message responds. The recipient is able to view the first proposal message starting from the to-do list. Again, the to-do list is shown in FIG. 4(a). As explained above, it contains an icon such as 42 when there are messages to which the recipient has not yet responded, irrespective of whether they are task messages or proposal messages. The recipient clicks on the area 41 as explained above, to go to the window shown in FIG. 4(b). He clicks on the area 43 to go to the window shown as 4(c) where the first proposal message is displayed in area 46.

If the recipient clicks on the area 46, the communication device displays a window shown in FIG. 7(a). This is called a “proposal bubble” 71, because it is similar to the a bubble of a conventional SMS conversation, except that it contains, in area 72, the five time options which the initiator of the first proposal message defined when the first proposal message was set up in step 201. For each of the five time options, there is a respective row. The row shows the time option, then the number of recipients of the first proposal message who have said that the time is convenient for them, then the number of recipients of the first proposal message who have not yet responded, then the number of recipients of the first proposal message who have said the time is not convenient. The proposal bubble of FIG. 5(a) indicates that two recipients of the first proposal message have indicated that they are free on Saturday at 12 pm, and two have indicated that they are available on Saturday at 3 pm. One recipient of the first proposal message has indicated that he or she is free on Saturday at 11 am, and one has indicated that he or she is available on Sunday at 11 am. Two recipients of the first proposal message have not yet responded. One recipient of the first proposal message has indicated that he or she is not available on Saturday at 11 am, two have indicated that they are not available on Saturday at 3 pm, and two recipients of the proposal message have indicated that they are not free on Saturday at 12 pm. Thus, Saturday at 12 pm and Saturday at 11 am are the most preferred times, and are indicated by a respective circle at the left of the area 72 of the proposal bubble 71.

The present recipient of the first proposal message (i.e. the one who is viewing the proposal bubble 71) is available on Saturday at 11 am or 12 pm, so he or she highlights the rows of area 72 corresponding to those two times. The mobile communication device associated with that recipient of the first proposal message transmits a response message to the server 7, indicating what the recipient has done. This completes step 209.

In step 210 the server 7 updates the record for the first proposal message, to show that this recipient of the first proposal message is available on Saturday at 11 am or 12 pm.

In step 211, the server 7 notes that the time of 12 pm on Saturday has now been accepted by three recipients of the first proposal message. The server determines that this means that a popularity criterion has been met (e.g. the criterion may be that a certain time option is acceptable to at least three recipients of the first proposal message). In this way the server predicts that there is a good chance that the first group will eventually choose 12 pm on Saturday (optionally, the server may take other factors into account too, such as calendar data from calendars of users in the first group who have not yet replied to the first proposal message). Following this determination, the server 7 updates the list of time options for the second proposal message to delete the time option of Saturday at 12 pm, and also the option of Saturday at 11.30 am which is too close to (i.e. less than a predetermined threshold time spacing from) Saturday at 12 pm.

In step 212, the server 7 communicates with the communication devices 1a, 1b, . . . , 1N of the initiator and the recipients of both proposal messages. During this communication, the server 7 sends them an update message which instructs them that that the first and second proposal messages should be updated. The update message contains at least data specifying how the proposal messages should be updated (i.e. the first proposal message is updated to show that an additional recipient of the first proposal message has selected Saturday at 12 pm, and the second proposal message is updated to show that the second proposal message is no longer associated with the time options of Saturday at 11.30 am or Saturday at 12 pm).

This communication between the server 7 and the communication devices 1a, 1b, . . . , 1N may be initiated by the server 7, for example by sending the update message. This update message may be triggered to be sent by the completion of step 211. Alternatively, the communication devices 1a, 1b, . . . , 1N may poll the server 7 (e.g. at periodically) to establish communication, and the server 7 may send the update message when the communication has been established.

The software applications running on the communication devices 1a, 1b, . . . , 1N of the initiator and all the recipients of the first and second proposal messages react to the update message by updating the proposal messages, so they are consistent with the update message(s) they receive (i.e. consistent with the updated proposal records). For example, the portion 72 of the recipient's GUI may now appear as shown in FIG. 7(b).

Optionally, as for step 107, step 212 may be performed in multiple stages. In one option, the server 7 may, upon modifying the record in step 106, generate an update notification which is sent to the other communication devices saying that the record has been updated. The existence of this update notification may be displayed on the other communication devices. Subsequently, the recipient of the update notification may take some action (e.g. switching to a window of the GUI in which the proposal message is displayed) which causes the full update message to be downloaded and used to update the proposal message. Optionally, the update notification may only be sent if the response fulfils at least one significance criterion. For example, if the response was just to decline a certain option, this response may not be sufficiently important to trigger an update notification according the significance criterion.

In step 213 the server 7 determines if at least one termination criterion is met. One possible termination criterion is that all the recipients of the first and/or second proposal messages have now responded to them. Another possible termination criterion is that a certain time criterion is met, e.g. that a predetermined period has passed since the first and second proposal messages were initiated.

If the at least one termination criterion is not met, method 200 then returns to step 209, i.e. the next time one of the users responds to one of the proposal messages. For example, the same recipient of the first proposal message may in step 209 indicate that he or she is not free at times 3 pm, 11 am and 12 pm. Steps 210 and 211 are then repeated, so that the area 72 for of the proposal bubble now appears as in FIG. 7(c). The user may now click on “done”. In this case, the GUI may revert to the to-do list.

If in step 213 it is determined that the at least one termination criterion is met, a decision is made (e.g. by the initiator, or by the server 7 according to some predetermined algorithm) of which time option will be selected for each of the proposal messages. The decision for each proposal message will typically be which of the corresponding time options was approved by the greatest number of recipients.

The two decisions are communicated to the communication devices of the corresponding recipients (and to the communication device of the initiator, if it was not the initiator who made the decision). The GUI for one of the recipients of the first proposal message may now appear as in FIG. 7(d). This shows that 3 recipients of the first proposal message replied. 1 did not reply. Saturday at 12 pm was selected as the best option. This ends the method 200.

If the user corresponding to this GUI clicks on the area 73, the GUI displays a further to-do list, as in FIG. 7(e). The to-do list in FIG. 7(e) contains a row labelled “Need to reply”. The to-do list may collate multiple update notifications, as describe above. In the example of FIG. 7(e) the user has received two notification messages which indicate that input from the user is needed. If the user clicks on this he or she is taken to a single GUI which shows, e.g. in a “carousel” format, a list of the proposal messages and/or task messages which the user has received, for example a list of all the proposal messages and/or task messages to which the user has yet to reply. This provides a very fast way for the user to access all messages that require attention across any of the groups that user belongs to.

Another GUI any individual may be able to access is an “agreed to do” list. This is a summary of all the tasks the individual has accepted, for all the groups of which the individual is a member. This means that the individual does not have to open groups (or channels, in the case that multiple communication channels have been created for a given group) successively to obtain a list of all the tasks he or she has to perform.

Although method 200 has been explained with reference to just two proposal messages, in variations of the method the initiator may create more than two proposal messages. Upon a predefined criterion being met by responses to any of the proposal messages, any conflicting options may be removed from the other proposal messages.

Furthermore, FIG. 6 is also applicable to a situation in which the two action messages are not proposal messages, but rather task messages. In this case, the action records are not proposal records, but rather task records. In this case, examples of when options (i.e. task components) of a first task message conflict with options (i.e. task components) of a second task message would be when a certain task component of one task message is unnecessary when a certain task component of the other task message has been accepted by one of the users. For example, each of the task messages may contain a task component to bring a certain item to a certain event, and when one of the recipients of one of the task messages accepts this task component, the other task message can be updated to delete that task component.

Far more complex examples are also possible. Suppose that there are three groups of individuals. Each group is a team at a different location, and the teams need to bring several items for a joint meeting in a fourth location. Some items are to be delivered by many individuals (e.g. course preparation), some are restricted (e.g. a total of 15 sandwiches are needed, so when a sufficient number of individuals, from any team, have accepted the task of bringing a sandwich, this task component is satisfied), some are mutually exclusive (e.g. only 1 stop watch is needed, and it does not matter who bring is), some are restricted to a groups (e.g. a presentation is needed from only from two specific teams, but not the third team). In this case, three task messages may be sent to the respective groups of individuals, and the server stores three respective task messages with sufficient additional information to define all the information above, showing the potential conflicts between them, such that selection of task components by a recipient of one of the task messages can cause all the task messages to be updated.

FIG. 8 is a block diagram showing a technical architecture of the server 7.

The technical architecture includes a processor 222 (which may be referred to as a central processor unit or CPU) that is in communication with memory devices including secondary storage 224 (such as disk drives), read only memory (ROM) 226, random access memory (RAM) 228. The processor 222 may be implemented as one or more CPU chips. The technical architecture may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution.

In this embodiment, the secondary storage 224 has an order processing component 224a comprising non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 220 to provide the functionality of a number of servers that is not directly bound to the number of computers in the technical architecture 220. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture, at least one of the CPU 222, the RAM 228, and the ROM 226 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

FIG. 9 is a block diagram showing a technical architecture of any one the communication devices 1a, 1b, . . . , 1N.

The technical architecture includes a processor 322 (which may be referred to as a central processor unit or CPU) that is in communication with memory devices including secondary storage 324 (such as disk drives or memory cards), read only memory (ROM) 326, random access memory (RAM) 328. The processor 322 may be implemented as one or more CPU chips. The technical architecture further comprises input/output (I/O) devices 330, and network connectivity devices 332.

The I/O devices comprise a user interface (UI) 330a, a camera 330b and a geolocation module 330c. The UI 330a may comprise a touch screen (2a, 2b, 2N in FIG. 1), keyboard (3a, 3b, 3N in FIG. 1), keypad or other known input device. The camera 330b allows a user to capture images and save the captured images in electronic form. The geolocation module 330c is operable to determine the geolocation of the communication device using signals from, for example global positioning system (GPS) satellites.

The secondary storage 324 is typically comprised of a memory card or other storage device and is used for non-volatile storage of data and as an over-flow data storage device if RAM 328 is not large enough to hold all working data. Secondary storage 324 may be used to store programs which are loaded into RAM 328 when such programs are selected for execution.

In this embodiment, the secondary storage 324 has an order generation component 324a, comprising non-transitory instructions operative by the processor 322 to perform various operations of the method of the present disclosure. The ROM 326 is used to store instructions and perhaps data which are read during program execution. The secondary storage 324, the RAM 328, and/or the ROM 326 may be referred to in some contexts as computer readable storage media and/or non-transitory computer readable media.

The network connectivity devices 332 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 332 may enable the processor 322 to communicate with the Internet or one or more intranets. With such a network connection, it is contemplated that the processor 322 might receive information from the network, or might output information to the network in the course of performing the above-described method operations. Such information, which is often represented as a sequence of instructions to be executed using processor 322, may be received from and outputted to the network, for example, in the form of a computer data signal embodied in a carrier wave.

The processor 322 executes instructions, codes, computer programs, scripts which it accesses from hard disk, floppy disk, optical disk (these various disk based systems may all be considered secondary storage 324), flash drive, ROM 326, RAM 328, or the network connectivity devices 332. While only one processor 322 is shown, multiple processors may be present. Thus, while instructions may be discussed as executed by a processor, the instructions may be executed simultaneously, serially, or otherwise executed by one or multiple processors.

Whilst the foregoing description has described exemplary embodiments, it will be understood by those skilled in the art that many variations of the embodiment can be made within the scope and spirit of the present invention.

For example, users might be enabled to update the task messages and/or proposal messages in respect of information relating to other users. For example, a given user who knows that another user will not be available at a certain time which is an option in a proposal message, may be able to respond to a proposal message on behalf of the other user, to decline that time option.

For example, it is possible for a single message to play the role of both a task message and a proposal message. This would happen, for example, if the initiator completes all fields of the template message shown in FIG. 3, i.e. defining both task components and options.

In another example, an initiator might define two task messages for respective groups of users. Each task message contains a respective set of task options, but some task options may be shared between the messages. Thus, there may be any of (a) task components which are present in only one of the task messages, (b) task components which are present in both messages and which either group of users may accept. If a user who is a member of one of the groups of users accepts a task component of type (b) in the corresponding task message, that task component may disappear from the task components of the other task message. In other words, responses by one group of users to one task message may modify the task components of the other group of users.

Indeed, an initiator might be able to define a single task message and/or proposal message which is sent to multiple groups of users, and such that each group of users is associated with a different set of task components and/or options. Typically, the communication devices of each group of users will only display the corresponding associated task components and/or options.

In a further variation, the server 7 (or one of the commication devices 1a, 1b, . . . 1N) may be operative to communicate with users (especially ones who do not have access to a communication device on which the software application is installed) in some other manner than as described above, such as by conventional email. For example, the server 7 may be able to a notification email containing the task message and/or proposal message to such a user, and receive a response to it by email. The server may then be operative to update the record according to the response. Note that this user will not benefit from all the advantages of the invention, but at least the other users will be able to view task messages/proposal messages which incorporate his or her responses. To enable the server to be able to interpret the email responses automatically, it may be helpful to encode certain data into the header of the notification email, or the return address to which responses to the notification email are sent. The data enables the server to identify the corresponding record easily. For example, the data may be an identity number of the record.

1. A computer-implemented method of associating individuals with components of a task, the individuals each being associated with respective communication devices, the method comprising:
(i) transmitting a task message to a plurality of the communication devices, the task message specifying one or more task components and being associated with a record in a message database;
(ii) a respective software application installed on each communication device displaying the task message in a graphical user interface using a screen of the corresponding communication device;
(iii) the software application on at least one of the communication devices receiving data input from the corresponding individual indicating an acceptance of a task component specified by the task message, and transmitting a corresponding response message;
(iv) updating the record to associate the corresponding individual with the accepted task component; and
(v) transmitting to the plurality of communication devices an update message to modify the task message in relation to the accepted task component, wherein the software applications subsequently display the modified task message on the communication devices.

2. A method according to claim 1 further including receiving from at least one of the individuals data input specifying a modification to the task components, and, in response to the data input, transmitting to the plurality of communication devices an update message, the update message including an instruction to modify the task message to specify the modified task components, wherein the software applications subsequently display the modified task message on the communication devices.

3. A method according to claim 2 in which the modification is the addition of at least one additional task component.

4. A method according to claim 3 in which the at least one additional task component is associated with an existing task component.

5. A method according to claim 2 in which the modification is the splitting of a task component into a plurality of task components.

6. A method according to claim 1 further including determining, following step (iii), whether the number of individuals associated with the accepted task component is below a predefined participant number, and only performing steps (iv) and (v) if the determination is positive.

7. A method according to claim 1 including determining, following step (iii), whether the individual corresponding to the mobile device where the data input was received satisfies one or more criteria associated with the accepted task component, and only performing steps (iv) and (v) if the determination is positive.

8. A method according to claim 1 in which the database is maintained by a computer device,
upon step (iii) being performed, the at least one communication device transmitting a response message to the computer device,
the computer device performing step (iv) upon receiving the response message, and
the computer device performing step (v).

9. A method according to claim 1 further including:
the software application on a communication device associated with an individual associated with a task component receiving data input indicating the status of the task component, the software application transmitting a corresponding response message;
updating the record to indicate the status; and
transmitting to the plurality of communication devices an update message to modify the task message in relation to the status of the accepted task component.

10. A method according to claim 1 in which the action message is a message according to an instant messaging or SMS protocol.

11-14. (canceled)

15. A method according to claim 1 in which the software application corresponding to an individual, is operative to display a list of the task messages which the corresponding communication device has received.

16. A method according to claim 15 in which the displayed list of task messages is operative to receive data input from the individual, to modify the displayed task messages which the corresponding communication device has received.

17. A computer device operative to associate individuals with components of a task, the individuals each being associated with respective communication devices,
the computer device comprising a processor and a data storage device, the data storage device storing program instructions operative to cause the processor:
(i) to receive from a plurality of the communication devices response messages, the response messages being generated in response to a task message received by the communication devices, the task message specifying one or more task components;
(ii) based on the response messages, to update a record in a message database, the record corresponding to the task message, the updating comprising associating one of the individuals with at least one of the task components in the case of task messages, or at least one proposal option selection in the case of proposal messages; and
(iii) to transmit to the plurality of communication devices an update message to modify the task message in relation to the accepted task component, or the proposal message in relation to the chosen proposal option selection whereby the communication devices subsequently display the modified task message on the communication devices.

18. A computer device according to claim 17 in which the program instructions are further operative to cause the processor:
upon receiving a response message in a predetermined format, to update the record to modify one or more of the task components, and
to generate the update message in a format including an instruction to modify the task message to specify the modified task components.

19. (canceled)

20. (canceled)

21. A tangible data storage device storing in non-transitory form program instructions operative to cause a processor of a communication device:
(i) to display a task message specifying one or more task components;
(ii) to receive data input indicating an acceptance of a task component specified by the task message;
(iii) to transmit a response message indicative of the data input;
(iv) to receive an update message to modify the task message in relation to the accepted task component; and
(v) to display the modified task message.

22. A data storage device according to claim 21 in which the program instructions are operative to cause the processor to display a list of the task messages which the corresponding communication device has received.

23. A data storage device according to claim 22 in which the list of task messages is displayed within a graphical user interface which is operative to receive said data input from the individual indicating acceptance of a task component specified by the task message.

24. A data storage device according to claim 21 in which the program instructions are operative to cause the processor to display a list of task components with which the individual has become associated.

25. A data storage device according to claim 21, in which the program instructions are further operative to cause the processor:
(i) to display a proposal message specifying one or more options;
(ii) to receive data input indicating an acceptance of one of the options;
(iii) to transmit a response message indicative of the data input;
(iv) to receive an update message to modify the proposal message in relation to the accepted option; and
(v) to display the modified proposal message.

26. A data storage device according to claim 25 in which program instructions are operative to cause the processor to display a list of the proposal messages which the corresponding communication device has received within a graphical user interface which is operative to receive said data input from the individual indicating acceptance of one of the options.

27. (canceled)
